(19) United States
(12) Patent Application Publication
(10) Pub. No.: US 2011/0256283 A1
(43) Pub. Date: Oct. 20, 2011

(54) Method for Preventing Decomposition/Deterioration of Lipophilic Component in the Presence of Water

(75) Inventors: Yasuharu Hashimoto, Osaka (JP); Jinji Shono, Osaka (JP); Akiko Kamoi, Osaka (JP); Nobuaki Tsuge, Osaka (JP); Masaki Nakamura, Osaka (JP); Tadashi Hamajima, Osaka (JP); Morihiro Aoyagi, Osaka (JP); Nobuhide Nakagawa, Osaka (JP)

(73) Assignee: HOUSE FOODS CORPORATION, Higashi-Osaka-shi (JP)

(21) Appl. No.: 13/141,285

(22) PCT Filed: Dec. 24, 2009
(86) PCT No.: PCT/JP2009/071473

§ 371 Date: Jun. 21, 2011

(30) Foreign Application Priority Data
Dec. 24, 2008 (JP) 2008-328262

(51) Int. Cl. A23L 3/3454

(52) U.S. Cl. 426/330

(57) ABSTRACT

Provided is a method for preventing decomposition/deterioration of a lipophilic component due to interaction with water, or due to interaction with light, enzymes, oxygen, or heat in the presence of water. The method for preventing decomposition/deterioration of the lipophilic component in the presence of water is characterized in that a complex comprising a lipophilic component, a phytosterol ester, and a cyclodextrin is formed, and the aforementioned lipophilic component is preserved in the form of said complex in the presence of water.

### TECHNICAL FIELD

The present invention relates to a method for preventing decomposition/deterioration of a lipophilic component.

### BACKGROUND ART

Lipophilic components are decomposed/deteriorated due to interaction with water, or interaction with light, an enzyme, oxygen, heat, or the like in the presence of water. With relation to a method for preventing such decomposition/deterioration, some food packaging materials have been proposed (Patent Document 1) in which the antimicrobial effects of isothiocyanate is retained even after heat drying in the following manner. Specifically, the stability of isothiocyanate is improved in such a manner that isothiocyanate included in a cyclodextrin is kneaded with a synthesis resin to form films, sheets and trays, or contained in a printing ink or a paint, which is then printed or applied onto films. These are stable in dry state, but can not retain sufficient storage stability in a state where water content is high, for example, in beverages and high water content foods.

Meanwhile, a hydrophilic composite material of an L-ascorbic acid higher fatty acid ester imparted with stability with time, and stability against heat can be obtained by adding a fat-soluble L-ascorbic acid higher fatty acid ester to water or a hydrophilic solution in which a cyclodextrin is dissolved, and stirring the mixture at 50 to 100° C. (Patent Document 2). However, this method has a problem that especially substances unstable in the presence of water are likely to undergo reaction such as decomposition, because of contact with water or the hydrophilic solvent, and besides because of exposure to high-temperature during the inclusion. In addition, it cannot be said that the stability of the obtained composite material is sufficient.

Patent Document 1: Japanese Patent Application Publication No. Hei. 7-46973

Patent Document 2: Japanese Patent Application Publication No. Hei 10-231224

### SUMMARY OF THE INVENTION

### Problems to be Solved by the Invention

An object of the present invention is to provide a method for preventing decomposition/deterioration of a lipophilic component due to interaction with water, or due to interaction with light, an enzyme, oxygen, heat, or the like in the presence of water.

### Means for Solving the Problems

The present invention provides a method for preventing decomposition/deterioration of a lipophilic component, the method comprising: forming a composite material containing the lipophilic component, a phytosterol ester, and a cyclodextrin; and storing the lipophilic component in a form of the composite material in the presence of water.

### Effects of the Invention

The present invention makes it possible to prevent decomposition/deterioration, with time, of a lipophilic component due to interaction with water, or due to interaction with light, an enzyme, oxygen, heat, or the like in the presence of water. This makes it possible to keep functionalities and color of materials susceptible to decomposition, such as components of spices and unsaturated fatty acids, in beverages and high water content foods for a long period of time.

### BRIEF DESCRIPTION OF THE DRAWINGS

FIG. 1 is a graph showing change in allyl amount in Example 1 and Comparative Example 1.

FIG. 2 is a graph showing change in capsaicin amount in Example 2 and Comparative Example 2.

FIG. 3 is a graph showing change in ratio of remaining capsinoids in Example 3, and Comparative Examples 3-1 and 3-2.

FIG. 4 is a graph showing change of gingerol being stored in Example 4 and Comparative Example 4.

FIG. 5 is a graph showing change of shogaol being stored in Example 4 and Comparative Example 4.

FIG. 6 is a graph showing change of piperine being stored in Example 5 and Comparative Example 5.

### MODES FOR CARRYING OUT THE INVENTION

A lipophilic component to which the present invention is applied is a lipophilic component which undergoes decomposition/deterioration due to interaction with water, or due to interaction with light, an enzyme, oxygen, heat, or the like in the presence of water. Specific examples thereof include mustard extracts containing allyl isothiocyanate; turmeric extracts such as curcumin; capsicum pepper extracts containing capsaicinoids, capsinoids, and the like; ginger extracts containing gingerol, shogaol, zingerone, and the like; pepper extracts containing piperine and the like; unsaturated fatty acids susceptible to oxidation such as docosahexaenoic acid (DHA), eicosapentaenoic acid (EPA), and the like; and so on. Mustard extracts containing allyl isothiocyanate have such a nature as to be easily decomposed with time in the presence of water. Turmeric extracts such as curcumin have such a nature as to be easily decomposed with time due to interaction with light in the presence of water. Capsaicinoids have such a nature as to be easily decomposed with time due to interaction with an enzyme in the presence of water. Capsinoids have such a nature as to be easily decomposed with time in the presence of water. Ginger extracts such as gingerol, shogaol, and zingerone have such a nature as to be easily decomposed with time in the presence of water. Pepper extracts such as piperine have such a nature as to be easily decomposed with time in the presence of water. Unsaturated fatty acids such as docosahexaenoic acid and eicosapentaenoic acid have such a nature as to be decomposed/deteriorated with time due to interaction with oxygen in the presence of water.

The phytosterol ester used in the present invention is a substance obtained by ester-bonding a fatty acid to a hydroxyl group in the sterol skeleton of a plant sterol. Examples of a production method of the phytosterol ester include an enzymatic method utilizing an enzyme; and the like. Examples of the enzymatic method include a method of obtaining the phytosterol ester by mixing the phytosterol and the fatty acid and by causing reaction therebetween (at 30 to 50° C. for approximately 48 hours), with a lipase or the like used as a catalyst; and the like. Other synthesis methods include a method of obtaining the phytosterol ester by esterification which involves dehydration of a plant sterol produced from soybean or the like with a fatty acid obtained from rapeseed oil, corn oil, or the like, in the presence of a catalyst; and the like.

Examples of the plant sterol include sterols contained in vegetable fats and oils, and the like. For example, the plant sterol may be one extracted and purified from a vegetable fat or oil of soybean, rapeseed, cottonseed, or the like. The plant sterol may be a mixture containing β-sitosterol, campesterol, stigmasterol, brassicasterol, fucosterol, dimethylsterol, and the like. For example, a soybean sterol contains 53 to 56% of sitosterol, 20 to 23% of campesterol and 17 to 21% of stigmasterol. As the plant sterol, one which is commercially-available as “phytosterol F” (produced by TAMA BIOCHEMICAL CO., LTD.) can also be used.

The fatty acid may be plant-derived, for example, derived from rapeseed oil or palm oil, or animal-derived. Examples of the fatty acid include myristic acid, stearic acid, palmitic acid, arachidonic acid, oleic acid, linoleic acid, α-linolenic acid, γ-linolenic acid, eicosapentaenoic acid, docosahexaenoic acid, palmitoleic acid, lauric acid, and the like.

Preferred examples of the phytosterol ester include phytosterols each obtained from a phytosterol derived from soybean and a fatty acid derived from rapeseed oil; phytosterols each obtained from a phytosterol derived from soybean or rapeseed and a fatty acid derived from palm oil; and the like. The former include “San Sterol NO. 3” of San-Ei Gen F. F. I., Inc., and the like, and the latter include “phytosterol fatty acid ester” of TAMA BIOCHEMICAL CO., LTD., and the like.

The cyclodextrin used in the present invention refers to a cyclic non-reducing maltooligosaccharide, whose constitutional unit is glucose. Even though any one of α-cyclodextrin with six glucose units, β-cyclodextrin with seven glucose units, and γ-cyclodextrin with eight glucose units may be used, γ-cyclodextrin is preferable since γ-cyclodextrin is decomposed by human digestive enzymes and since γ-cyclodextrin is easy to use for foods and beverages, particularly for beverages because of the its high solubility in water.

In the present invention, by forming the above-described composite material of the lipophilic component, the phytosterol ester, and the cyclodextrin, and by storing the lipophilic component in the form of the composite material in the presence of water, decomposition/deterioration, with time, of a lipophilic component due to interaction with water, or due to interaction with light, an enzyme, oxygen, heat, or the like in the presence of water can be prevented. The composite material herein can be produced by a method comprising a compositing step of forming a composite material by mixing a lipophilic component, a phytosterol ester, and a cyclodextrin in the presence of water. For producing the composite material of the present invention, the amount of the phytosterol ester is preferably, for example, 0.5 to 30000 parts by weight with respect to one part by weight of the lipophilic component. Note that a higher proportion of the phytosterol ester provides a greater effect of preventing the decomposition. However, this results in a greater amount of the cyclodextrin to be added, so that the relative proportion of the lipophilic component is reduced. The amount of the cyclodextrin is, for example, preferably 0.01 to 1000 parts by weight, and more preferably 0.1 to 100 parts by weight with respect to one part by weight of the phytosterol ester. The amount of water coexisting in producing the composite material is, for example, preferably 0.01 to 100 parts by weight, and more preferably 0.1 to 10 parts by weight, with respect to one part by weight of the cyclodextrin. In addition, when the composite material of the present invention is produced, the mixing is preferably conducted under heating at 40 to 90° C., more preferably at 50 to 85° C.

In producing the composite material, the order of adding and mixing water, the lipophilic component, the phytosterol ester, and the cyclodextrin is not particularly limited. For example, the composite material is preferably formed as follows: the lipophilic component and the phytosterol ester (and water, when the dispersibility is poor) are mixed with each other to prepare a mixture, while the cyclodextrin cyclo is dispersed in water to prepare another mixture; subsequently the two mixtures are mixed with each other. However, the order is not limited thereto, and, for example, the lipophilic component, the phytosterol ester, the cyclodextrin, and water may be mixed with each other simultaneously.

In the mixing of the lipophilic component and the phytosterol ester, any mixing conditions and means can be employed, as long as an appropriate dispersibility is achieved.

After the cyclodextrin was added, a mixing device with high shearing force, such as a kneader, is preferably used in order to achieve sufficient kneading for obtaining the composite material.

In the present invention, the lipophilic component is stored in the form of the thus obtained composite material in the presence of water. More specifically, for example, by adding the lipophilic component in the form of the thus obtained composite material to a food, a beverage, a pharmaceutical drug, a cosmetic, or the like containing water, and then storing the mixture, decomposition/deterioration, with time, of a lipophilic component due to interaction with water, or due to interaction with light, an enzyme, oxygen, heat, or the like in the presence of water can be prevented.

### EXAMPLES

### Example 1

To 5.67 parts by weight of a phytosterol ester melted by heating to 60° C., 0.63 parts by weight of a mustard essential oil was added, and dissolved thereinto. Meanwhile, 62.4 parts by weight of γ-cyclodextrin and 31.3 parts by weight of water (75° C.) were introduced into a mortar, and mixed with a pestle, to obtain a paste. To this paste, the above-described phytosterol ester in which the mustard essential oil was dissolved was added, and the mixture was kneaded in a hot water (75° C.) for 10 minutes. After completion of the kneading, water in an amount equivalent to water lost due to vaporization was added thereto, and the mixture was kneaded again to homogeneity. The blended amounts (g) in Example 1 are shown in the following Table 1.

### Comparative Example 1

Into a mortar, 66.24 parts by weight of γ-cyclodextrin, and 33.13 parts by weight of water (60° C.) were added, and mixed with each other using a pestle to obtain a paste. To this paste, 0.63 parts by weight of a mustard essential oil was added, and the mixture was kneaded in a hot water (75° C.) for 10 minutes. After completion of the kneading, water in an amount equivalent to water lost due to vaporization was added thereto, and the mixture was kneaded again to homogeneity. The blended amounts (g) in Comparative Example 1 are shown in the following Table 1.

TABLE 1

| | | Comparative |
|---|---|---|
| Raw material | Example 1 | Example 1 |
| mustard essential oil | 0.63 g | 0.63 g |
| (allyl isothiocyanate content: | | |
| 97 weight percent) | | |
| phytosterol ester | 5.67 g | — |
| (San Sterol NO. 3 of San-Ei | | |
| Gen F. F. I., Inc.) | | |
| γ-cyclodextrin | 62.40 g | 66.24 g |
| water | 31.30 g | 33.13 g |
| total | 100.00 g | 100.00 g |

### (Storage Method)

To one part by weight of each of the samples obtained in Example 1 and Comparative Example 1, 5 parts by weight of water was added, and uniformly dispersed therein. GC vials were filled up with the water-dispersion composite material samples, then each were tightly closed with a cap, and sealed into an aluminum pouch. These vials were stored at 50° C.

### (GC Measurement)

The samples stored for zero days (at the beginning of the storage), one day, and six days were diluted 100-fold with hexane, allowed to stand at room temperature for 16 to 18 hours, and filtered through a 0.45-μm filter to prepare GC samples. For the GC measurement, a FID detector was used. The measurement was carried out under the following conditions.

Column: DB-WAX (Inner diameter: 0.53 mm, Length: 30 m, Film thickness: 1 μm)

Carrier gas: helium gas

Back pressure: 20 kPa

Injection temperature: 200° C.

Detector temperature: 220° C.

Temperature rise conditions: Temperature was raised from 100° C. to 180° C. (at a rate of temperature rise of 20° C./min)

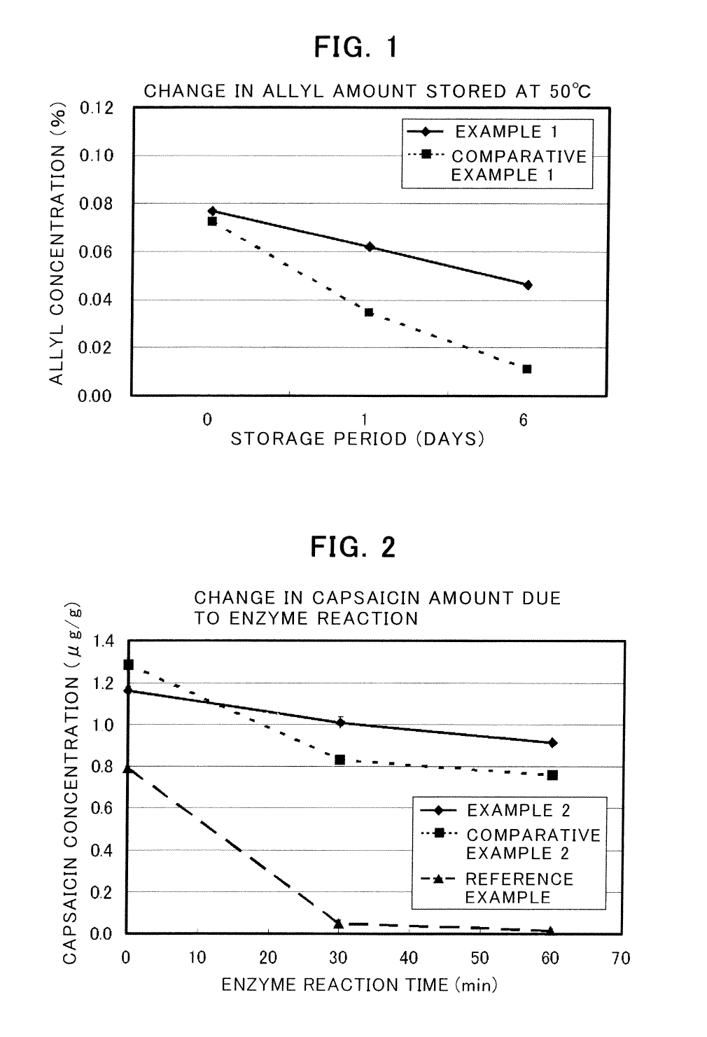

FIG. 1 shows change in allyl concentration. As shown in FIG. 1, when the mustard essential oil was stored in the presence of water in the form of the composite material which was formed together with the phytosterol ester and γ-cyclodextrin, the decomposition of allyl isothiocyanate in the oil was apparently prevented. Note that, the ratio of allyl isothiocyanate remaining after the 6-day storage was 60.2% in Example 1 and 15.5% in Comparative Example 1 with respect to that at the beginning of the storage.

### Example 2

To 3.5 parts by weight of a phytosterol ester heated to 60° C. and dissolved, 0.07 parts by weight of capsicum oleoresin was added, and dissolved thereinto. Meanwhile, 64.3 parts by weight of γ-cyclodextrin and 32.13 parts by weight of water (60° C.) were introduced into a mortar, and mixed with a pestle, to obtain a paste. To this paste, the above-described phytosterol ester in which the capsicum oleoresin was dissolved was added, and the mixture was kneaded in a hot water (60° C.) for 10 minutes. After completion of the kneading, water in an amount equivalent to water lost due to vaporization was added thereto, and the mixture was kneaded again to homogeneity. The blended amounts (g) in Example 2 are shown in the following Table 2.

### Comparative Example 2

Into a mortar, 66.6 parts by weight of γ-cyclodextrin, and 33.33 parts by weight of water (60° C.) were added, and mixed with each other using a pestle to obtain a paste. To this paste, 0.07 parts by weight of a capsicum oleoresin was added, and the mixture was kneaded in a hot water (60° C.) for 10 minutes. After completion of the kneading, water in an amount equivalent to water lost due to vaporization was added thereto, and the mixture was kneaded again to homogeneity. The blended amounts (g) in Comparative Example 2 are shown in the following Table 2.

TABLE 2

| | | Comparative |
|---|---|---|
| Raw material | Example 2 | Example 2 |
| capsicum oleoresin | 0.07 g | 0.07 g |
| (capsaicins content: | | |
| 40 weight percent) | | |
| phytosterol ester | 3.50 g | — |
| (San Sterol NO. 3 of San-Ei | | |
| Gen F. F. I., Inc.) | | |
| γ-cyclodextrin | 64.30 g | 66.60 g |
| water | 32.13 g | 33.33 g |
| total | 100.00 g | 100.00 g |

### (Enzyme Addition and Storage Method)

Each of the samples obtained in Example 2 and Comparative Example 2 was diluted 10-fold with a 50 mM Tris buffer (capsaicin concentration: 0.0028%). To this, an acylase was added to give a concentration of 0.05 u/ml. The mixture was shaken in a constant-temperature water bath at 37° C., to allow the reaction of the enzyme.

Meanwhile, as Reference Example, a capsaicin reagent (capsaicin content: 95% or higher) manufactured by SIGMA was diluted with a 50 mM Tris buffer to have the same capsaicin concentration (0.0028%) as Example 2 and Comparative Example 2. To this, an acylase was added to give a concentration of 0.05 u/ml. The mixture was shaken in a constant-temperature water bath at 37° C. in the same manner as Example 2 and Comparative Example 2, to allow the reaction of the enzyme.

### (HPLC Measurement)

To 2 ml of each sample in which the reaction of the enzyme was allowed for 0 minutes (at the beginning of the shaking), 30 minutes, or 60 minutes, 3 ml of water was added, and thus the volume thereof was adjusted to 5 ml. Moreover, 1 ml of 2.5N NaOH was added thereto, followed by heating in boiling water at 100° C. for 10 minutes. After the heating, 20 ml of methanol was added thereto. To this mixture, 1 ml of 2.5N HCl was added, and the volume was adjusted with methanol to 50 ml. Then, the mixture was filtered through a 0.45-μm filter, and used as a HPLC sample. For the HPLC measurement, a fluorescence detector was used. The measurement was carried out under the following conditions.

Column: ODS (Senshu Scientific Co., Ltd.)

Flow rate: 1 ml/min

Mobile phase: acetonitrile:TFA=1:1

Injection amount: 2 μl

Detection: ex270, em330

FIG. 2 shows change in capsaicin concentration. As shown in FIG. 2, when the capsicum oleoresin was stored in the presence of water in the form of the composite material which was formed together with the phytosterol ester and γ-cyclodextrin, the decomposition of capsaicin in the capsicum oleoresin was apparently prevented. Note that, the ratio of capsaicin remaining after the reaction of the enzyme for 60 minutes was 78.6% in Example 2, 58.9% in Comparative Example 2, and 2.0% in Reference Example with respect to that at the beginning of the shaking.

### Example 3

Capsinoids extracted from “Natura” manufactured by AJINOMOTO CO., INC., were used.

To 0.70 parts by weight of a phytosterol ester heated to 70° C., 0.35 parts by weight of a fat and fatty oil containing the capsinoids was added, and dissolved thereinto. Meanwhile, 7.0 parts by weight of γ-cyclodextrin and 3.5 parts by weight of water were introduced into a mortar, and mixed with each other in a hot water bath at 70° C. to obtain a paste. To this paste, 1.05 parts by weight of the above-described oil phase in which the capsinoid was dissolved were added, and the mixture was kneaded in a hot water bath at 70° C. for 10 minutes to prepare a composite material. Into 87.6 parts by weight of water, 11.55 parts by weight of the obtained composite material, 0.56 parts by weight of citric acid, and 0.27 parts by weight of trisodium citrate were dispersed, and the dispersion was stirred with a mixer for 30 seconds. Thus, a model beverage containing composite material was prepared. The model beverage containing composite material was heated up to 93° C., and sterilized by being held at 90° C. for 3 minutes, and then filled into a pouch. Thereafter, the pouch was held in a constant-temperature water bath at 83° C. for 7 minutes to perform second sterilization.

### Comparative Example 3-1

Capsinoids extracted from “Natura” manufactured by AJINOMOTO CO., INC., were used.

To 0.70 parts by weight of refined rapeseed oil heated to 70° C., 0.35 parts by weight of a fat and fatty oil containing the capsinoids was added, and dissolved thereinto. To 10.2 parts by weight of water, 0.33 parts by weight of an emulsifier (polyglycerin fatty acid ester SWA-10D manufactured by Mitsubishi- Kagaku Foods Corporation) and 1.05 parts by weight of the above-described oil phase in which the capsinoid was dissolved were added, and the mixture was emulsified with a mixer to prepare an emulsion. Into 87.6 parts by weight of water, 11.58 parts by weight of the obtained emulsion, 0.56 parts by weight of citric acid, and 0.27 parts by weight of trisodium citrate were dispersed, and the dispersion was stirred with a mixer for 30 seconds. Thus, an emulsion-containing model beverage was prepared. The emulsion-containing model beverage was heated up to 93° C., and sterilized by being held at 90° C. for 3 minutes, and then filled into a pouch. Thereafter, the pouch was held in a constant-temperature water bath at 83° C. for 7 minutes to perform second sterilization.

### Comparative Example 3-2

Capsinoids extracted from “Natura” manufactured by AJINOMOTO CO., INC., were used.

To 0.70 parts by weight of refined rapeseed oil heated to 70° C., 0.35 parts by weight of a fat and fatty oil containing the capsinoids was added, and dissolved thereinto. On the other hand, 7.0 parts by weight of γ-cyclodextrin, and 3.5 parts by weight of water were introduced into a mortar, and mixed with each other in a hot water bath at 70° C. to obtain a paste. To this paste, 1.05 parts by weight of the above-described oil phase in which the capsinoids were dissolved was added, and the mixture was kneaded in a hot water bath at 70° C. for 10 minutes. Thus, a composite material was prepared. Into 87.6 parts by weight of water, 11.55 parts by weight of the obtained composite material, 0.56 parts by weight of citric acid, and 0.27 parts by weight of trisodium citrate were dispersed, and the dispersion was stirred with a mixer for 30 seconds. Thus, a model beverage containing composite material was prepared. The model beverage containing composite material was heated up to 93° C., and sterilized by being held at 90° C. for 3 minutes, and then filled into a pouch. Thereafter, the pouch was held in a constant-temperature water bath at 83° C. for 7 minutes to perform second sterilization.

TABLE 3

| | Example | Comparative | Comparative |
|---|---|---|---|
| Raw material (in part by weight) | 3 | Example 3-1 | Example 3-2 |
| fat and fatty oil containing | 0.35 | 0.35 | 0.35 |
| capsinoids | | | |
| (extracted from “Natura” | | | |
| manufactured by AJINOMOTO | | | |
| CO., INC.) | | | |
| β-sitosterol | 0.70 | — | — |
| refined rapeseed oil | — | 0.70 | 0.70 |
| (manufactured by J-OIL MILLS, | | | |
| INC.) | | | |
| γ-cyclodextrin | 7.0 | — | 7.0 |
| water | 3.5 | 10.2 | 3.5 |
| emulsifier | — | 0.33 | — |
| (SWA-10D manufactured by | | | |
| Mitsubishi-Kagaku Foods | | | |
| Corporation) | | | |
| citric acid | 0.56 | 0.56 | 0.56 |
| trisodium citrate | 0.27 | 0.27 | 0.27 |
| water | 87.6 | 87.6 | 87.6 |
| total | 100 | 100 | 100 |

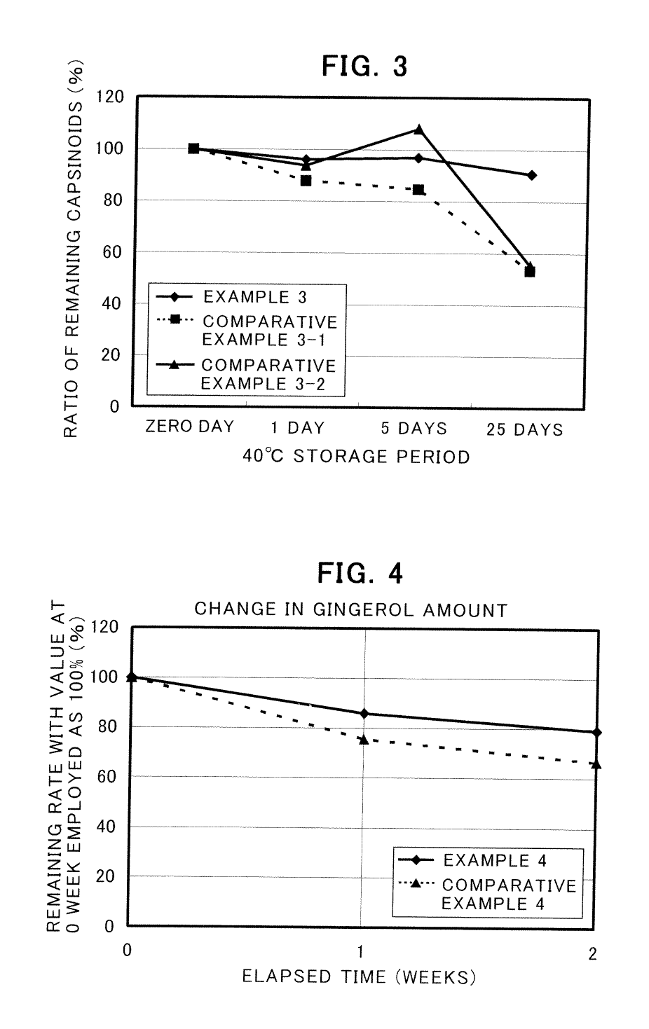

The model beverages prepared in Example 3, and Comparative Examples 3-1 and 3-2 were stored at 40° C. After certain periods of time had elapsed, the capsinoids in the samples were quantitatively determined by liquid chromatography. For the ratio of remaining capsinoids, values determined after the beverages were stored for a day, 5 days, and 25 days at 40° C. were represented by percentage, with a value of the capsinoids immediately after the start of the storage (zero days) being employed as 100%. FIG. 3 shows the results. As is apparent from FIG. 3, the decomposition of the capsinoids in the storage at 40° C. was more markedly prevented in Example 3 than Comparative Examples 3-1 and 3-2. From the results described above, it has been found that the present invention makes it possible to prevent the decomposition of capsinoids in the presence of water, and to improve the stability thereof.

### Pretreatment Method for Liquid Chromatography

Regarding each of Example 3 and Comparative Example 3-2, 12.5 g of the model beverage was centrifuged (at 3000 rpm for 10 minutes), and then the supernatant was removed. To the deposit, 6 ml of DMSO (dimethyl sulfoxide) was added, and the mixture was ultrasonicated to dissolve the deposit. Moreover, the mixture was diluted with methanol to 25 ml, filtered through a 0.45-μm filter, and then used as a test liquid.

Regarding Comparative Example 3-1, 5 g of the model beverage was sampled. The sample was diluted with methanol to 10 ml, filtered through a 0.45-μm filter, and then used as a test liquid.

Measurement Conditions for Liquid Chromatography

A fluorescence detector was used.

Column mightysil (250 mm, φ2.0)

Flow rate 0.2 ml/min

Injection Amount 3 μl

Mobile Phase pH 3.3 TFA-water:acetonitrile=20:80

FLD Detector EX270 EM330

### Example 4

As a ginger extract, a supercritical ginger extract (gingerol: 24.8%, shogaol: 10.7%, Takasago International Corporation) was used.

To 0.18 parts by weight of a phytosterol ester and 0.12 parts by weight of an edible fat and fatty oil, which were heated to 80° C., 0.015 parts by weight of the ginger extract was added, and dissolved therein. On the other hand, 1.093 parts by weight of γ-cyclodextrin, and 1.093 parts by weight of water were mixed with a TK homomixer, while being heated to 80° C. To this mixture, 0.315 parts by weight of the above-described oil phase in which the ginger extract was dissolved was added. While continuously being heated to 80° C., the resultant mixture was stirred with a TK homomixer to conduct preliminary emulsification. After the preliminary emulsification, the mixture was passed through a high-pressure homogenizer (LAB1000 manufactured by SMT Co., Ltd., pressure: 100 MPa). Thus, a ginger extract-containing composite material was prepared. Into 97.08 parts by weight of water, 2.5 parts by weight of the obtained composite material, 0.3 parts by weight of citric acid, and 0.12 parts by weight of trisodium citrate were dispersed, and the dispersion was stirred with a mixer for 30 seconds. Thus, a ginger extract model beverage containing composite material was prepared. The ginger extract model beverage containing composite material was heated up to 93° C., and sterilized by being held at 90° C. for 3 minutes, and then filled into a pouch. Thereafter, the pouch was held in a constant-temperature water bath at 83° C. for 5 minutes to perform second sterilization. In the prepared ginger extract model beverage containing composite material, the gingerol component was 36.1 ppm, and the shogaol component was 15.4 ppm.

### Comparative Example 4

Here, an emulsified preparation obtained by emulsifying a ginger extract (gingerol: 1.79%, shogaol: 0.89%, Takasago International Corporation) was used. Into 99.35 parts by weight of water, 0.23 parts by weight of the obtained emulsified preparation, 0.3 parts by weight of citric acid, and 0.12 parts by weight of trisodium citrate were dispersed, and the dispersion was stirred with a mixer for 30 seconds. Thus, a ginger extract emulsified preparation-containing model beverage was prepared. The ginger extract emulsified preparation-containing model beverage was heated up to 93° C., and sterilized by being held at 90° C. for 3 minutes, and then filled into a pouch. Thereafter, the pouch was held in a constant-temperature water bath at 83° C. for 5 minutes to perform second sterilization. In the prepared ginger extract emulsified preparation-containing model beverage, the gingerol component was 40.9 ppm, and the shogaol component was 16.2 ppm.

TABLE 4

| | | Comparative |
|---|---|---|
| Raw material (in part by weight) | Example 4 | Example 4 |
| ginger extract | 0.015 | — |
| (supercritical ginger extract gingerol: | | |
| 24.8%, shogaol: 10.7%, manufactured by | | |
| Takasago International Corporation) | | |
| ginger extract | — | 0.23 |
| (emulsified preparation gingerol: 1.79%, | | |
| shogaol: 0.89%, manufactured by | | |
| Takasago International Corporation) | | |
| phytosterol ester | 0.18 | — |
| (San Sterol NO. 3 manufactured by | | |
| San-Ei Gen F. F. I.) | | |
| edible fat and fatty oil | 0.12 | — |
| γ-cyclodextrin | 1.093 | — |
| water | 1.093 | — |
| citric acid | 0.3 | 0.3 |
| trisodium citrate | 0.12 | 0.12 |
| water | 97.08 | 99.35 |
| total | 100 | 100 |

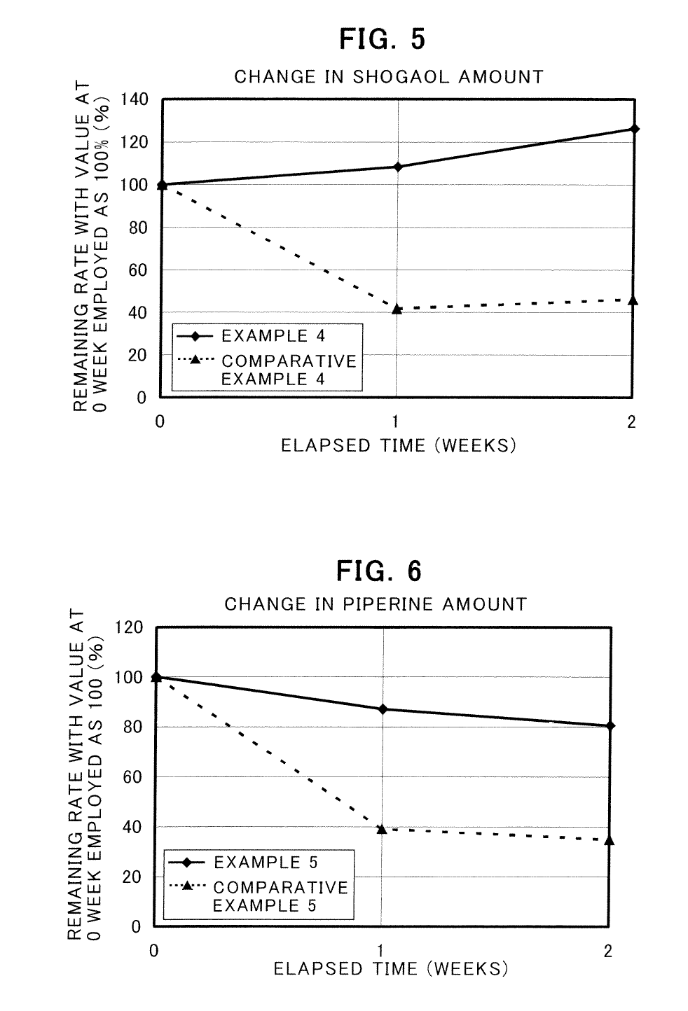

The model beverages prepared in Example 4 and Comparative Example 4 were stored at 40° C. The gingerols and shogaols in the samples before the storage, stored for a week, and the stored for 2 weeks were quantitatively determined by liquid chromatography. For the ratio of remaining gingerols and shogaols, values determined after the beverages were stored for a week and for 2 weeks were represented by percentage, with values of the gingerols and shogaols before the storage (zero weeks) being employed as 100%. FIGS. 4 and 5 show the results. As is apparent from FIGS. 4 and 5, the decomposition of the gingerols and especially the shogaols were prevented in Example 4 than Comparative Example 4. From the results described above, it has been found that the present invention makes it possible to prevent the decomposition of ginger extracts in the presence of water, and to improve the stability thereof.

### Pretreatment Method for Liquid Chromatography

Regarding Example 4, 25 g of the model beverage was centrifuged (at 3000 rpm for 10 minutes), and then the supernatant was removed. To the deposit, 3 ml of DMSO (dimethyl sulfoxide) was added, and the mixture was ultrasonicated to dissolve the deposit. Moreover, the mixture was diluted with methanol to 50 ml, filtered through a 0.45-μm filter, and then used as a test liquid.

Regarding Comparative Example 4, 25 g of the model beverage was sampled. The sample was diluted with methanol to 50 ml, filtered through a 0.45-μm filter, and then used as a test liquid.

### Measurement Conditions for Liquid Chromatography

UV: 282 nm

Column: ODS C18 (Senshu Scientific Co., Ltd.)

Flow rate: 1.0 ml/min

Injection amount: 20 μl

Analysis time: 30 minutes

Mobile phase: acetonitrile:water:THF (tetrahydrofuran)=45:50:5

### Example 5

As a pepper extract, piperine powder (piperine content: 92% or more, Inabata Koryo Co., Ltd) was used.

To 0.18 parts by weight of a phytosterol ester and 0.12 parts by weight of an edible fat and fatty oil, which were heated to 80° C., 0.0064 parts by weight of the pepper extract was added, and dissolved therein. On the other hand, 1.097 parts by weight of γ-cyclodextrin, and 1.097 parts by weight of water were mixed with a TK homomixer, while being heated to 80° C. To this mixture, 0.3064 parts by weight of the above-described oil phase in which the pepper extract was dissolved was added. While continuously being heated to 80° C., the resultant mixture was stirred with a TK homomixer to conduct preliminary emulsification. After the preliminary emulsification, the mixture was passed through a high-pressure homogenizer (LAB1000 manufactured by SMT Co., Ltd., pressure: 100 MPa). Thus, a pepper extract-containing composite material was prepared. Into 97.08 parts by weight of water, 2.5 parts by weight of the obtained composite material, 0.3 parts by weight of citric acid, and 0.12 parts by weight of trisodium citrate were dispersed, and the dispersion was stirred with a mixer for 30 seconds. Thus, a pepper extract model beverage containing composite material was prepared. The pepper extract model beverage containing composite material was heated up to 93° C., and sterilized by being held at 90° C. for 3 minutes, and then filled into a pouch. Thereafter, the pouch was held in a constant-temperature water bath at 83° C. for 7 minutes to perform second sterilization. In the prepared pepper extract model beverage containing composite material, the piperine amount was 62 ppm.

### Comparative Example 5

Here, a Piper longum of the Piperaceae family extract (piperines content: 300 to 1400 ppm, Maruzen Pharmaceuticals Co., Ltd.) was used.

Into 99.43 parts by weight of water, 0.15 parts by weight of the pepper extract, 0.3 parts by weight of citric acid, and 0.12 parts by weight of trisodium citrate were dispersed, and the dispersion was stirred with a mixer for 30 seconds. Thus, a pepper extract model beverage containing composite material was prepared. The pepper extract model beverage containing composite material was heated up to 93° C., and sterilized by being held at 90° C. for 3 minutes, and then filled into a pouch. Thereafter, the pouch was held in a constant-temperature water bath at 83° C. for 5 minutes to perform second sterilization. In the prepared pepper extract model beverage containing composite material, the piperine amount was 0.25 ppm.

TABLE 5

| | | Comparative |
|---|---|---|
| Raw material (in part by weight) | Exam ple 5 | Example 5 |
| pepper extract | 0.0064 | — |
| (piperine powder piperine content: 92% or | | |
| more, manufactured by Inabata Koryo Co., | | |
| Ltd) | | |
| pepper extract | — | 0.15 |
| (Piper longum of the Piperaceae family | | |
| extract (piperines component: | | |
| 300 to 1400 ppm, manufactured by | | |
| Maruzen Pharmaceuticals Co., Ltd.) | | |
| phytosterol ester | 0.18 | — |
| (San Sterol NO. 3 manufactured by San-Ei | | |
| Gen F. F. I.) | | |
| edible fat and fatty oil | 0.12 | — |
| γ-cyclodextrin | 1.097 | — |
| water | 1.097 | — |
| citric acid | 0.3 | 0.3 |
| trisodium citrate | 0.12 | 0.12 |
| water | 97.08 | 99.43 |
| total | 100 | 100 |

The model beverages prepared in Example 5, and Comparative Example 5 were stored at 60° C. The piperines in the samples before the storage, stored for a week, and stored for 2 weeks were quantitatively determined by liquid chromatography. For the ratio of remaining piperines, values determined after the beverages were stored for a week and for 2 weeks were represented by percentage, with a value of the piperines before the storage (zero weeks) being employed as 100%. FIG. 6 shows the results. As is apparent from FIG. 6, the decomposition of the piperines was more prevented in Example 5 than Comparative Example 5. From the results described above, it has been found that the present invention makes it possible to prevent the decomposition of piperines in the presence of water, and to improve the stability thereof.

### Pretreatment Method for Liquid Chromatography

Regarding Example 5, 10 g of the model beverage was centrifuged (at 3000 rpm for 10 minutes), and then the supernatant was removed. To the deposit, 3 ml of DMSO (dimethyl sulfoxide) was added, and the mixture was ultrasonicated to dissolve the deposit. Moreover, the mixture was diluted with methanol to 50 ml, filtered through a 0.45-μm filter, and then used as a test liquid.

Regarding Comparative Example 5, the sample was diluted with methanol, filtered through a 0.45-μm filter, and then used as a test liquid.

Measurement Conditions for Liquid Chromatography

UV: 343 nm

Column: YMCPack ODS-A

Flow rate: 1.0 ml/min

Injection amount: 5 μl

Mobile phase: acetonitrile:water:THF (tetrahydrofuran)=45:55:7

### Example 6

As an unsaturated fatty acid, a deodorized fish oil “DHA-22HG” containing 22% or more of DHA (manufactured by Maruha Nichiro Foods, Inc.) was used.

To 0.9 parts by weight of a phytosterol ester, 0.455 parts by weight of the deodorized fish oil containing DHA was added. The mixture was heated to 70° C. with stirring, and the deodorized fish oil was dissolved therein. Thus, a phytosterol ester in which the deodorized fish oil containing DHA was dissolved was prepared. Separately, 10 parts by weight of γ-cyclodextrin and 5 parts by weight of water (90° C.) were mixed with each other to prepare a mixture (paste). To the mixed paste, the phytosterol ester in which the deodorized fish oil containing DHA was dissolved was added. By using a mortar, the mixture was kneaded for 10 minutes, while being heated to 70° C. to prepare a composite material. To the composite material, 82.895 parts by weight of water was added with mixing. Subsequently, 0.5 parts by weight of citric acid and 0.25 parts by weight of trisodium citrate were added thereto, and mixed therewith. Furthermore, the resultant mixture was stirred with a homomixer at 5000 rpm for 2 minutes to obtain a homogeneous white liquid. The white liquid was heated up to 93° C. with stirring, then introduced into a colorless transparent glass container, and then cooled. Thus, a packaged beverage was produced. Note that the pH of the beverage was 3.4.

### Comparative Example 6-1

As an unsaturated fatty acid, a deodorized fish oil “DHA-22HG” containing 22% or more of DHA (manufactured by Maruha Nichiro Foods, Inc.) was used.

To 0.9 parts by weight of a phytosterol ester, 0.455 parts by weight of the deodorized fish oil containing DHA was added. The mixture was heated to 70° C. with stirring, and the deodorized fish oil was dissolved therein. Thus, a phytosterol ester in which the deodorized fish oil containing DHA was dissolved was prepared. Separately, 0.5 parts by weight of an emulsifier was dissolved in 14.5 parts by weight of water (at 70° C.). To the emulsion, the phytosterol ester in which the deodorized fish oil containing DHA was dissolved was added, and the mixture was stirred with a homomixer at 5000 rpm for 10 minutes to prepare an emulsion. To the emulsion, 82.895 parts by weight of water was added with mixing, and subsequently 0.5 parts by weight of citric acid and 0.25 parts by weight of trisodium citrate were added thereto and mixed therewith. Then, the mixture was heated up to 93° C. with stirring, then introduced into a colorless transparent glass container, and then cooled. Thus, a packaged beverage was produced. Note that the pH of the beverage was 3.4.

### Comparative Example 6-2

As an unsaturated fatty acid, a deodorized fish oil “DHA-22HG” containing 22% or more of DHA (manufactured by Maruha Nichiro Foods, Inc.) was used.

To 0.9 parts by weight of refined rapeseed oil, 0.455 parts by weight of the deodorized fish oil containing DHA was added. The mixture was heated to 70° C. with stirring, and the deodorized fish oil was dissolved therein. Thus, refined rapeseed oil in which the deodorized fish oil containing DHA was dissolved was prepared. Separately, 0.5 parts by weight of an emulsifier was dissolved in 14.5 parts by weight of water (at 70° C.). To the emulsion, the refined rapeseed oil in which the deodorized fish oil containing DHA was dissolved was added, and the mixture was stirred with a homomixer at 5000 rpm for 10 minutes to prepare an emulsion. To the emulsion, 82.895 parts by weight of water was added with mixing, and subsequently 0.5 parts by weight of citric acid and 0.25 parts by weight of trisodium citrate were added thereto and mixed therewith. Then the mixture was heated up to 93° C. with stirring, then introduced into a colorless transparent glass container, and then cooled. Thus, a packaged beverage was produced. Note that the pH of the beverage was 3.4.

### (Evaluation of Beverages)

The packaged beverages were placed in a thermostatic chamber (“SANYO GROWTH CABINET” at a temperature of 25° C. and an illuminance of 10000 lx), and stored for 6 days. After the storage, the odor (fishy odor) of the beverages was subjected to sensory evaluation. The blending ratios and the results of the sensory evaluation are shown in the following Table 6. From these results, it has been found that deterioration of the deodorized fish oil containing DHA can be prevented by the present invention.

TABLE 6

| | | | Comparative | Comparative |
|---|---|---|---|---|
| | | Example 6 | Example 6-1 | Example 6-2 |
| blending | deodorized fish oil | 0.455 | 0.455 | 0.455 |
| ratio | (“DHA-22HG” | | | |
| (in part by | (Maruha Nichiro | | | |
| weight) | Foods, Inc.)) | | | |
| | phytosterol ester | 0.9 | 0.9 | — |
| | (“San Sterol NO. | | | |
| | 3” (San-Ei Gen | | | |
| | F. F. I.)) | | | |
| | refined rapeseed | — | — | 0.9 |
| | oil | | | |
| | (manufactured by | | | |
| | J-OIL MILLS, | | | |
| | INC.) | | | |
| | γ-cyclodextrin | 10 | — | — |
| | emulsifier | — | 0.5 | 0.5 |
| | (“ryoto ester SWA- | | | |
| | 10D” Mitsubishi- | | | |
| | Kagaku Foods | | | |
| | Corporation) | | | |
| | water | 5 | 14.5 | 14.5 |
| | (anhydrous) citric | 0.5 | 0.5 | 0.5 |
| | acid | | | |
| | trisodium citrate | 0.25 | 0.25 | 0.25 |
| | water | 82.895 | 82.895 | 82.895 |
| | total | 100 | 100 | 100 |

| | | | |
|---|---|---|---|
| sensory evaluation (fishy odor) | almost no | strong odor | strong odor |
| | odor was | was noticed | was noticed |
| | noticed | | |

### Example 7

As an unsaturated fatty acid, a deodorized fish oil “DHA-22HG” containing 22% or more of DHA (manufactured by Maruha Nichiro Foods, Inc.) was used.

To 0.9 parts by weight of a phytosterol ester, 0.455 parts by weight of the deodorized fish oil containing DHA was added. The mixture was heated to 70° C. with stirring, and the deodorized fish oil was dissolved therein. Thus, a phytosterol ester in which the deodorized fish oil containing DHA was prepared. Separately, 10 parts by weight of γ-cyclodextrin and 5 parts by weight of water (90° C.) were mixed with each other to prepare a mixture (paste). To the mixed paste, the phytosterol ester in which the deodorized fish oil containing DHA was dissolved was added. By using a mortar, the mixture was kneaded for 10 minutes, while being heated to 70° C. to prepare a composite material. To the composite material, 82.895 parts by weight of water was added with mixing. Subsequently, 0.5 parts by weight of citric acid and 0.25 parts by weight of trisodium citrate were added thereto, and mixed therewith. Furthermore, the resultant mixture was stirred with a homomixer at 5000 rpm for 2 minutes to obtain a homogeneous white liquid. The white liquid was heated up to 93° C. with stirring, then introduced into a colorless transparent glass container, and then cooled. Thus, a packaged beverage was produced. Note that the pH of the beverage was 3.4.

### Comparative Example 7

As an unsaturated fatty acid, a deodorized fish oil “DHA-22HG” containing 22% or more of DHA (manufactured by Maruha Nichiro Foods, Inc.) was used.

10 parts by weight of γ-cyclodextrin and 5 parts by weight of water (90° C.) were mixed with each other to prepare a mixture (paste). To the mixed paste, the phytosterol ester in which the deodorized fish oil containing DHA was dissolved was added. By using a mortar, the mixture was kneaded for 10 minutes, while being heated to 70° C. to prepare a composite material. To the composite material, 82.895 parts by weight of water was added with mixing. Subsequently, 0.5 parts by weight of citric acid and 0.25 parts by weight of trisodium citrate were added thereto, and mixed therewith. Furthermore, the resultant mixture was stirred with a homomixer at 5000 rpm for 2 minutes to obtain a homogeneous white liquid. The white liquid was heated up to 93° C. with stirring, then introduced into a colorless transparent glass container, and then cooled. Thus, a packaged beverage was produced. Note that the pH of the beverage was 3.4.

### (Evaluation of Beverages)

The packaged beverages were placed in a thermostatic chamber (“SANYO GROWTH CABINET” at a temperature of 25° C. and an illuminance of 10000 lx), and stored for 6 days. After the storage, the odor (fishy odor) of the beverages was subjected to sensory evaluation. Furthermore, peroxide values were measured (measurement method: acetic acid-isooctane method). The blending ratios and the results of the sensory evaluation are shown in the following Table 7. From these results, it has been found that deterioration of the deodorized fish oil containing DHA can be prevented by the present invention.

TABLE 7

| | | | Comparative |
|---|---|---|---|
| | | Example 7 | Example 7 |
| blending ratio | deodorized fish oil | 0.455 | 0.455 |
| (in part by | (“DHA-22HG” (Maruha | | |
| weight) | Nichiro Foods, Inc.)) | | |
| | phytosterol ester | 0.9 | — |
| | (“San Sterol NO. 3” (San-Ei | | |
| | Gen F. F. I.)) | | |
| | γ-cyclodextrin | 10 | 10 |
| | water | 5 | 5 |
| | (anhydrous) citric acid | 0.5 | 0.5 |
| | trisodium citrate | 0.25 | 0.25 |
| | water | 82.895 | 83.795 |
| | total | 100 | 100 |

| | | |
|---|---|---|
| sensory evaluation (fishy odor) | almost no | strong odor |
| | odor was | was noticed |
| | noticed | |
| peroxide value (meq/kg) | 58 | 618 |

1. A method for preventing decomposition/deterioration of a lipophilic component in the presence of water, comprising:
forming a composite material containing the lipophilic component, a phytosterol ester, and a cyclodextrin; and
storing the lipophilic component in a form of the composite material in the presence of water.

2. The method according to claim 1, wherein the lipophilic component is selected from the group consisting of mustard extracts, capsicum pepper extracts, ginger extracts, pepper extracts, unsaturated fatty acids, and turmeric extracts.
